(19) United States
(12) Patent Application Publication
(10) Pub. No.: US 2017/0060494 A1
(43) Pub. Date: Mar. 2, 2017

(54) METHODS AND ARRANGEMENTS RELATING TO PRINTING PROCESS

(71) Applicant: MARKEM-IMAJE HOLDING, Bourg-Les-Valence (FR)

(72) Inventors: Mikael PALMEN, Lindome (SE); Jimmy KARLSSON RENNER, Goteborg (SE); Johan UNG, Goteborg (SE)

(73) Assignee: Markem-Imaje Holding, Bourg-Les-Valence (FR)

(21) Appl. No.: 15/307,291

(22) PCT Filed: Apr. 29, 2015
(86) PCT No.: PCT/IB2015/000956

§ 371 Date: Oct. 27, 2016

Related U.S. Application Data
(60) Provisional application No. 61/985,490, filed on Apr. 29, 2014.

(51) Int. Cl. G06F 3/12

(52) U.S. Cl. CPC G06F 3/1215; G06F 3/1208; G06F 3/1256; G06F 3/1282

(57) ABSTRACT

The present invention relates to a method and an arrangement for controlling a print output from a print device on an information carrier. The arrangement comprises a processing unit and a memory unit, and the method comprises: generating a print job data with respect to a type of print device, the information carrier and data in the memory unit, analyzing the generated print job data for approval with respect to a number of predetermined parameters.

### TECHNICAL FIELD

The present invention relates to printing processes in general and quality assurance of a print job in particular. Especially, the invention relates to simulating print assignments in industrial printers before actual printing is carried out.

### BACKGROUND

Consumer and industrial goods require a great deal of product identification (e.g., expiring dates, traceability data, etc.). The information to be printed may vary from one item to another, from one batch of similar items to another, from one site or time of manufacture to another, and/or from one type of print technology to another.

One example of an industrial coding and marking environment may be the printing of labels on various types of packages or consumer goods.

Another example is where multiple coding and marking printers, either of same technology or of different technologies are configured to simultaneously print information on various types of products or items (2 sides of a package, combination of visible and invisible printed information, etc.).

Printing and labelling is an importing step in production and packaging of goods.

In an industrial printing environment, numerous printers are typically configured to substantially simultaneously print information on various types of items. Consumer goods require a great deal of product identification (e.g., expiring dates, traceability data, etc.). Different parameters affect the result of printing, e.g.:

Speed, which may depend on the space between the goods or belt conveyor speed,

Surface type (material),

Surface shape,

Printer head and/or print technology,

Environmental parameters, such as humidity, ambient temperature, contamination, and/or

A combination thereof.

The information to be printed may also vary from one item to another, from one batch of similar items to another, and/or from one site or time of manufacture to another.

Thus, it is of great importance to achieve a good quality print result independent of above mentioned exemplary parameters.

In case of barcodes, for example, slight impairment of the printed barcode may affect the scanning result.

According to a normal procedure, tests are made before actual printing job, whereby a number of printouts may be made to control the result (ocular or scanning) based on which, printers or other items (such as conveyer speed) are adapted to achieve a good result. The procedure is time consuming and may stop or reduce production speed before acceptable print outs are available.

### SUMMARY

The embodiments of the present invention solve above mentioned problems and aids to minimise packaging and purchase costs and eliminate unnecessary print assignments resulting in a faster, more consistent and more efficient production line. The invention is suitable for industrial print assignments.

Moreover, the present invention according to some embodiments solves one or several of problems including: to determine the optimal operating parameters to achieve a required readability and quality level of the print on the receiving surface type, removing the need to make numerous test prints, verifying quality with a separate barcode verifier and changing operating parameters for each test print to achieve the required barcode readability and quality.

The objectives may be achieved by means of a method in an arrangement for controlling a print output from a print device on an information carrier, the arrangement comprising a processing unit and a memory unit, the method comprising: generating a print job data with respect to a type of print device, the information carrier and data in the memory unit, and analyzing the generated print job data for approval with respect to a number of predetermined parameters. In one embodiment, generating the print job is achieved with respect to one or several of information receiver type, print surface material, information receiver coating, colour, gloss, reflectance, bleeding, optical density, absorbance, photo aging, environment parameters, temperature, humidity, illumination, print surface speed, print objects distance, print objects angle. In one embodiment, generating the print job is achieved with respect to one or several of dot frequency, coalescence of separately deposited drops, droplet deposition, jet staggering, jet speed, jet channel crosstalk, ink type, ink viscosity, ink drop shape, ink colour, laser type, laser wavelength, dwell time, pixel spacing, laser power, optical characteristics, e.g. barrel distortion, vignetting, galvo inertia, mirror inertia, print head voltage, thermal hysteresis, thermal neighbouring dot crosstalk, strobe time, strobe shape, ribbon type, ribbon density, ribbon colour, ribbon speed, resolution, dot size, dot shape. In another embodiment, for simulating and testing barcode quality, the quality test comprising one or several of edge determination, minimum reflectance, symbol contrast, minimum edge contrast, modulation, defects, decode and decodability. According to one embodiment, for simulating and testing two dimensional matrix symbols comprising one or several of symbol contrast, modulation, decode, unused error correction, fixed (finder) pattern damage, grid non-uniformity and axial non-uniformity. In one embodiment, for simulating and testing characters comprising one or several of global image analyses, grayscale image analyses, analyses of lines and line patterns, analyses of point patterns, and frequency domain analyses.

According to one embodiment, simulation result is provided to a controller for generating print job data with respect to the simulation result. One embodiment comprises simulating simultaneous simulation of several types of printers in a production line.

The invention also relates to an arrangement comprising a processing unit, a memory unit and communication unit for analysing and testing a print output, wherein the processing unit is configured to obtain a print job data comprising at least one image, the print job data being generated with respect to a type of print device, an information carrier and data in the memory unit, analysing the generated print job data for approval with respect to a number of predetermined parameters. According to one embodiment, the print job data is generated with respect to one or several of information receiver type, information receiver colour; gloss, reflectance, bleeding, optical density, absorbance, photo aging, environment parameters, such as temperature, humidity, illumination, print surface speed, print objects distance and parameters depending on the printer type.

According to one embodiment, the print job data is generated with respect to one or several of printing power (power to print head), dot frequency, time of burning, coalescence of separately deposited drops, ink type, droplet deposition, ribbon type, laser type, optical characteristics, e.g. barrel distortion, vignetting, jet speed, print head voltage, print head thermal hysteresis, galvo intertia, mirror inertia, resolution, dot size, dwell time, pixel spacing and laser power.

In one embodiment, the arrangement is configured for simulating and testing barcode quality, the quality test comprising one or several of edge determination, minimum reflectance, symbol contrast, minimum edge contrast, modulation, defects, decode and decodability.

In one embodiment, the arrangement is configured for simulating and testing two dimensional matrix symbols comprising one or several of symbol contrast, modulation, decode, unused error correction, fixed (finder) pattern damage, grid non-uniformity and axial non-uniformity.

In one embodiment, the arrangement is configured for simulating and testing characters comprising one or several of global image analyses, grayscale image analyses, analyses of lines and line patterns, analyses of point patterns, and frequency domain analyses, contrast analyses, edge analyses, spatial analyses, density analyses, histogram analyses, pattern recognition, shape recognition, optical character recognition.

In one embodiment, the arrangement is configured to determine a printer type(s) connected in a network. In one embodiment, the arrangement comprising means for generating new parameters for new analyses.

The invention also relates to a computer-readable medium comprising a plurality of computer-readable instructions for execution by a processor of a computer device, wherein execution of the instructions causes the processor to perform steps of:

generating a print job data with respect to a type of print device, an information carrier characteristics and data in from a memory unit, and analyzing the generated print job data for approval with respect to a number of predetermined parameters.

### BRIEF DESCRIPTION OF THE DRAWINGS

In the following, reference is made to the attached drawings, illustrating schematic embodiments of the present invention:

FIG. 1 is a diagram of an exemplary system in which methods and systems described herein may be implemented;

FIG. 2 illustrates a schematic view of simulation portion according to the present invention;

FIG. 3 illustrates a schematic view of simulation portion according to FIG. 2;

FIG. 4 is a flow diagram illustrating exemplary processing by the system of FIG. 1; and

FIG. 5 illustrates schematically a multi-print embodiment according to the present invention.

### DETAILED DESCRIPTION

The following detailed description refers to the accompanying drawings. The same reference numbers in different drawings may identify the same or similar elements.

The term “image,” as used herein, may refer to a digital or an analog representation of visual information (e.g., a picture, barcode, character, etc.).

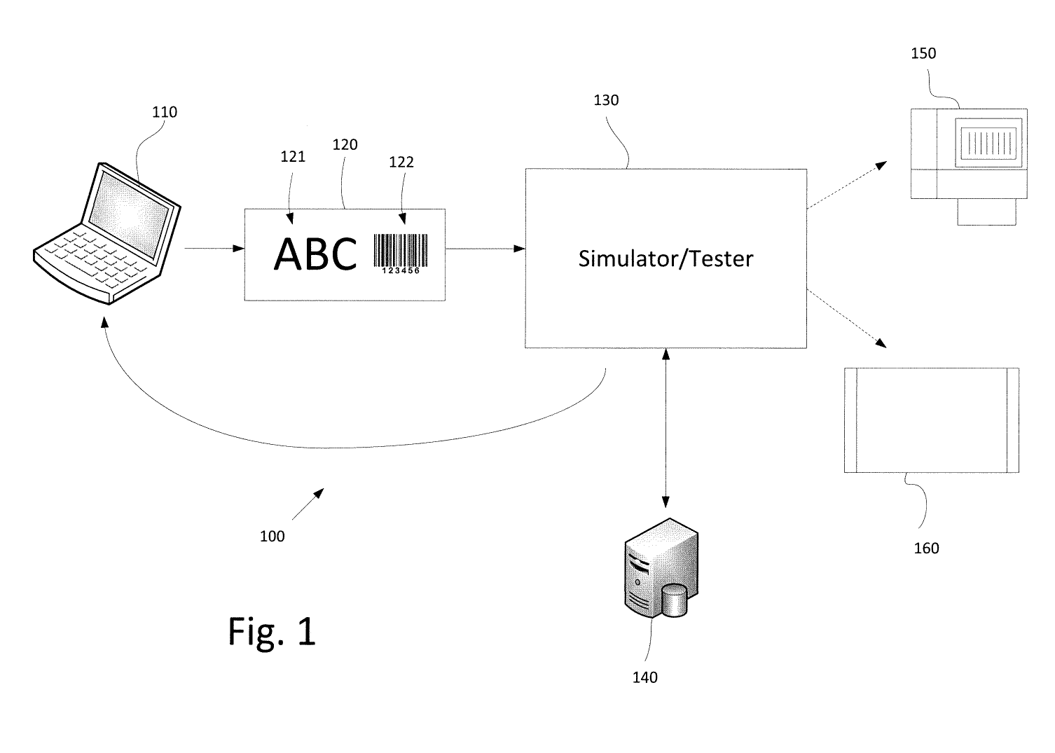

FIG. 1 illustrates a schematic system 100 in accordance with one aspect of the present invention. The system comprises a first means, such as a computer 110 for generating a print job data 120. The print job data 120 is provided to an arrangement 130 for simulating a printer output based on print job data 120. The print simulator module (PSM) 130 may also be configured to test the output. PSM 130 may be provided with other relevant data from a database 140. PSM 130 may output the result of the simulation and testing to a printer 150 or a controller 160.

In the following, the different parts of the invention according to the schematic embodiment of FIG. 1 are described in more detail:

The system 100 may be implemented as a software application in one or several computers or software procedures in a computer network.

In the embodiment of FIG. 1, a computer 110 is arranged to generate print data. The computer 110 may be part of a printer unit, such as an industrial printer. The computer may contain a dedicated application for generating specific types of print data, e.g. test print data and/or real print data. The application may comprise a label generator allowing a user to generate labels (120) comprising, characters (121), images, barcodes (122), etc. The test print as intended herein relates to data which is generated for inspection and test purposes and not used as actual print. However, this does not exclude testing actual print data.

According to this embodiment, the print job data is provided to the PSM 130, which with respect to a number of predetermined parameters simulates the print assignment and may decide the quality of printout, i.e. it simulates a printout in a printer. Based on the printout results, the parameters may be varied to find out the most suitable parameters.

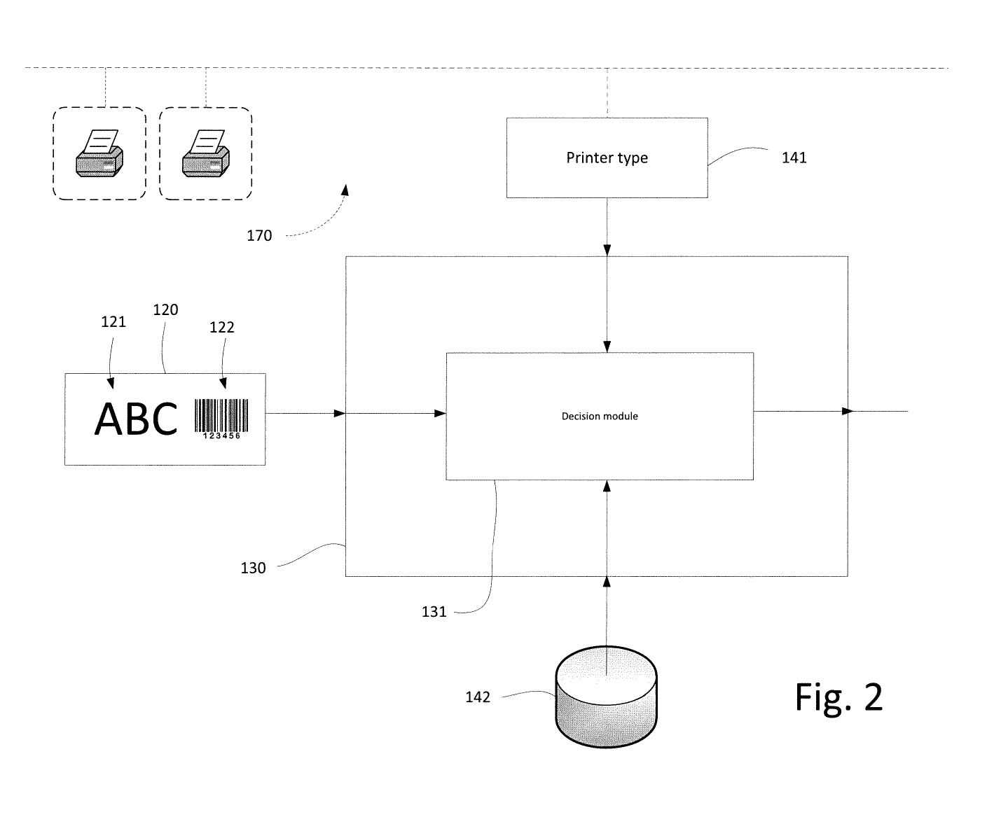

FIG. 2 illustrates schematics of an exemplary PSM 130 comprising a number of inputs, a decision module 131 and output. The inputs may be from a controller or computer providing PSM with print data (120), printer type 141, and a database (storage module) 142 providing PSM with relevant parameters, as will be discussed in more detail below.

The PSM may be configured to simulate variety of print technologies for printing codes or marks on labels or consumer and industrial products during their production and packaging. The PSM 130 may simulate technologies such as (but not limited to):

Continuous ink jet (CU);

Laser (matrix or vector scanning systems);

Thermal transfer over printing (TTO);

Valve ink jet;

Drop on demand piezo ink jet;

Thermal direct and thermal transfer label print and apply;

Table top label printing;

Radio Frequency ID (RFID); and

A combination thereof or any new generation print technologies.

The simulator may receive the printer type to be simulated from a controller/database 140 or detect the printer type(s) connected in a computer network 170.

Additional information for enabling simulation of the print job may be received from the database 140. The information may comprise one or several of:

Information receiver type, i.e. print surface material; such as paper, cardboard, plastic film, plastic, glass, labels, thermal labels, direct part marking, etc.,

Information receiver coating, colour, gloss, reflectance, bleeding, optical density, absorbance, photo aging, etc.

Environment parameters, such as temperature, humidity, illumination, etc.

Print surface(s) speed, i.e. the speed of the printing surface, e.g. on a conveyor, passing by the printer,

Print objects distance, i.e. the distance between the printer head and the information carrier surface,

Print objects angle, i.e. the angle between the printer head and the information carrier surface,

Specific parameters depending on the printer type, e.g.:

Dot frequency,

Coalescence of separately deposited drops,

Droplet deposition,

Jet staggering,

Jet speed,

Jet channel crosstalk,

Ink type,

Ink viscosity,

Ink drop shape,

Ink colour,

Laser type,

Laser wavelength,

Dwell time,

Pixel spacing,

Laser power,

Optical characteristics, e.g. barrel distortion, vignetting,

Galvo inertia,

Mirror inertia,

Print head voltage,

Thermal hysteresis,

Thermal neighbouring dot crosstalk,

Strobe time,

Strobe shape,

Ribbon type,

Ribbon density,

Ribbon color,

Ribbon speed,

Resolution,

Dot size,

Dot shape,

Etc.

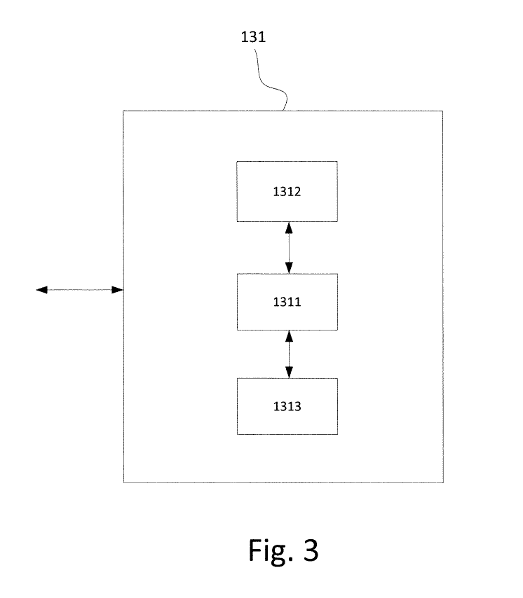

FIG. 3 illustrates a schematic view of a simple PSM 131 according to FIG. 2. The module may comprise a processing unit 1311, an interface unit 1312 and a memory unite 1313. The processing unit 1311 executes data from memory unit 1313 and handles data to be simulated received through interface unit 1312.

The print job is normally controlled by controlling a number of parameters in the printing device, which in turn may be dependent on the above information types. Depending on the printing technology different parameters may be elaborated.

One of the important features when applied in industrial printing is linear barcodes, and 2D codes such as QR-code, data-matrix and the like. A poor print quality may result in erroneous or failed scan output.

For controlling the bar code quality, today many groups including EAN International, the Uniform Code Council, ANSI/Material Handling Institute, the Automotive Industry Action Group (AIAG) and the Health Industry Bar Code Communication Council (HIBCC) have specified conformance to ANSI X3.182 Bar Code Print Quality Guideline and its parallel documents in Europe and the rest of the world. The guideline outlines the parameters of bar code quality from the ANSI, CEN and ISO Print Quality documents.

The present invention thus provides an arrangement to test the quality of the bar code before carrying out a print job.

For example, barcode according to following standards may be verified:

ISO/IEC 15416

ISO/IEC 15426-2

ISO/IEC TR 29158

Clearly other (feature) standards not listed may also be verified.

The simulated barcode can be tested against barcode quality standards by building a simulation of the barcode and simulating a verification not having to perform a print.

The simulation may comprise test of linear barcodes, e.g. including:

Edge Determination: In order to discern bars and spaces, a Global Threshold is established on the scan reflectance profile by drawing a horizontal line half way between the highest reflectance value and the lowest reflectance value seen in the profile. Edge Determination can then be done by counting the number of crossings at the Global Threshold confirming whether the count conforms to or is considered non-conforming to a known bar code symbology. If the barcode conforms it passes if it is considered non-conforming it fails.

Minimum Reflectance: A reflectance value for at least one bar must be equal to or less than half the highest reflectance value for a space.

Symbol Contrast: is the difference between the highest reflectance value and the lowest reflectance value anywhere in the scan reflectance profile, including the quiet zones. The higher the value the better the grade.

Minimum Edge Contrast: Each transition from a bar to a space, or a space to a bar, treating the quiet zones as spaces, is an “edge” whose contrast is determined as the difference between the peak values of space reflectance and bar reflectance in that space and that bar. Each edge in the scan profile may be measured and the edge that has the smallest change between adjacent elements gives the value for the Minimum Edge Contrast.

Modulation: i.e. how a scanner “sees” wide elements (bars or spaces) relative to narrow elements, as represented by reflectance values in the scan profile. For the same element widths scanners usually “see” spaces narrower than bars, and they also “see” narrow elements as being less distinct than wide ones. The scan reflectance profile typically shows narrow spaces being less intense or not as reflective as wide spaces, and narrow bars as being less dark than wide bars.

Defects: are voids found in bars or spots found in the spaces and quiet zones of the code, and show as an irregularity in the reflectance profile of the bar or space. Each element is individually evaluated for its reflectance non-uniformity. Element reflectance non-uniformity is the difference between the highest reflectance value and the lowest reflectance value found within a given element. Many elements may have zero non-uniformity.

Decode: bar code will Pass on Decode when the established bar and space widths can be converted into the correct series of valid characters using the standard Reference Decode algorithm (in the AIM technical specification or ANSI/CEN/ISO documents) for a given symbology and or application.

Decodability: is the measure of the accuracy of the printed bar code against the appropriate reference decode algorithm. Each symbology has published dimensional relationships for element widths and its decode algorithm provides margins or tolerances for errors in the printing and reading process. Decodability measures the amount of margin left for the reading process after printing the bar code, in the widths of elements or element combinations that are measured by the symbology decode algorithm. It does not necessarily correspond to bar width gain or loss although, depending on the symbology, these may well lead to a lower decodability value. Decodability may also be greatly affected by improper use of the contact optical input device on a verifier. Uneven scanning, acceleration or deceleration in the scan when verifying may cause the obtained grade to be lower than the actual grade.

For two dimensional matrix symbols tests may include:

Symbol Contrast

Modulation

Decode

Unused Error Correction

Fixed (finder) Pattern Damage

Grid Non-uniformity

Axial Non-uniformity

The test may also comprise testing image/character quality. These tests may include:

Dot Quality (including tests for dot placement accuracy and variations in dot formation)

Halftone Quality (including tests for area coverage)

Line Quality (including tests for sharpness and edge noise as well as detectability tests for negative lines)

Text Quality (including tests for connectivity and edge degradation)

Color Quality (including tests for color registration and CIE L* a* b* measurements)

Smear/Overspray

Spatial Resolution

According to the present invention the test may be carried out automatically in the decision module or be outputted to an output device, such as a display.

The decision module as described above may be used for image processing and analyses. The simulated print output is stored in image memory and retrieved by the processing unit 1311. The invention may use known image processing algorithms for analysing characters, figures and barcodes. These algorithms may include one or several of:

Global image analyses,

Grayscale image analyses,

Analyses of point patterns,

Frequency domain analyses,

Contrast analyses,

Edge analyses,

Spatial analyses,

Density analyses,

Histogram analyses,

Pattern recognition,

Shape recognition,

Optical character recognition,

Other suitable algorithms.

The above mentioned and other image processing and analyses will result in an output, which can be compared to threshold values for an acceptable print job. If the resulting simulation is not acceptable, parameters controlling the print job may be altered to achieve an acceptable print job.

The control may also be conducted manually. For example the simulation output may be displayed on a display and a user may use a scanning device, such as barcode scanner, to scan the image on the display. The scanned image is then converted to a number of values determining the image quality.

As mentioned earlier, the present invention according to some claims solves one or several of problems including:

to determine the optimal operating parameters to achieve a required readability and quality level of the print on the receiving surface type: according to one claim this may be achieved by generating a number test print outs, e.g. on a computer monitor, with same color and structure as the surface and using one or several parameters as mentioned earlier, and by ocular examination, using a scanner for test scan and examine the result and/or computer image analyses the quality and readability is determined;

removing the need to make numerous test prints: according to claims, no test print is needed as a computer monitor and/or computer analyses is used;

verifying quality with a separate barcode verifier and changing operating parameters for each test print to achieve the required barcode readability and quality; according to one claim this may be achieved by generating a number test prints, e.g. on a computer monitor and using one or several parameters as mentioned earlier, and using a barcode scanner test scanning and examining the result and/or computer image analyses the quality of the barcode is determined.

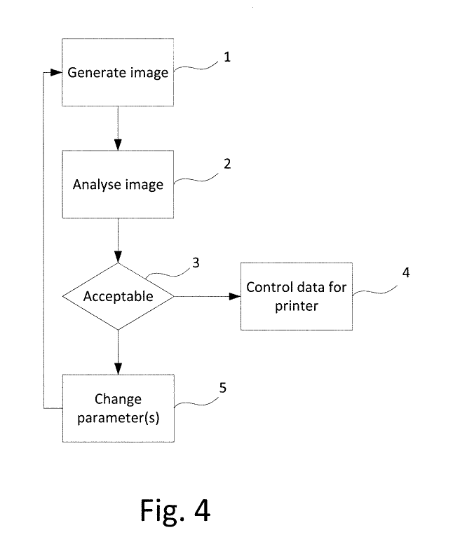

Thus, to sum up, the exemplary steps of the invention are illustrated in the follow diagram of FIG. 4:

in step (1) the print assignment to be tested is generated;

in step (2) the generated image is provided to the decision/testing module;

in step (3) the result of the analysed image is compared to an acceptable image;

in step (4) if the result is acceptable, the image assignment data may be sent to the printer; and

in step (5) if the analyse fails, print parameters are adjusted and a new image is analysed.

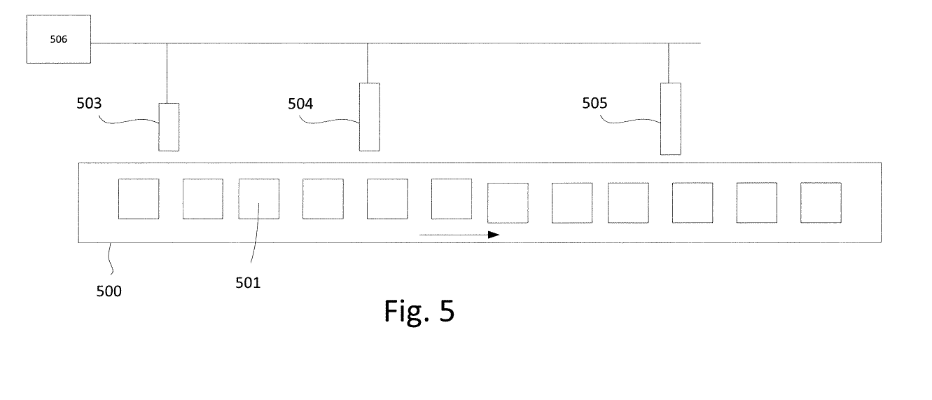

The invention may also be applied in applications comprising several printers of same or different types, as illustrated in FIG. 5. FIG. 5 illustrates a conveyer 500 carrying a number of objects 501, which are labelled using printers 503, 504 and 505 (connected in a network to a controller 506). The printers may be of same type such as laser printers, or one laser printer, one ink jet and one thermal printer. The printers may be configured to print on different surface of same object having different characteristics.

Thus, for a skilled person it is evident that testing all parameters, such as print surface, conveyer speed, print voltage, ink type etc. for such an application is time consuming. PSM of the invention may be configured to simulate several printers simultaneously. Thus, several parameters can be tested at same time. For example, the speed of the conveyer can be changed by simulating print times between different simulated printers to determine suitable print parameters, such as print head voltage, ink type, time of burning, etc. When suitable parameters are determined, these can be provided to the controller 506 to control the printers.

It should be noted that the word “comprising” does not exclude the presence of other elements or steps than those listed and the words “a” or “an” preceding an element do not exclude the presence of a plurality of such elements. It should further be noted that any reference signs do not limit the scope of the claims, that the invention may be implemented at least in part by means of both hardware and software, and that several “means”, “units” or “devices” may be represented by the same item of hardware.

The various embodiments of the present invention described herein is described in the general context of method steps or processes, which may be implemented in one embodiment by a computer program product, embodied in a computer-readable medium, including computer-executable instructions, such as program code, executed by computers in networked environments. A computer-readable medium may include removable and non-removable storage devices including, but not limited to, Read Only Memory (ROM), Random Access Memory (RAM), compact discs (CDs), digital versatile discs (DVD), etc. Generally, program modules may include routines, programs, objects, components, data structures, etc. that perform particular tasks or implement particular abstract data types. Computer-executable instructions, associated data structures, and program modules represent examples of program code for executing steps of the methods disclosed herein. The particular sequence of such executable instructions or associated data structures represents examples of corresponding acts for implementing the functions described in such steps or processes.

Software and web implementations of various embodiments of the present invention can be accomplished with standard programming techniques with rule-based logic and other logic to accomplish various database searching steps or processes, correlation steps or processes, comparison steps or processes and decision steps or processes. It should be noted that the words “component” and “module,” as used herein and in the following claims, is intended to encompass implementations using one or more lines of software code, and/or hardware implementations, and/or equipment for receiving manual inputs.

The foregoing description of embodiments of the present invention, have been presented for purposes of illustration and description. The foregoing description is not intended to be exhaustive or to limit embodiments of the present invention to the precise form disclosed, and modifications and variations are possible in light of the above teachings or may be acquired from practice of various embodiments of the present invention. The embodiments discussed herein were chosen and described in order to explain the principles and the nature of various embodiments of the present invention and its practical application to enable one skilled in the art to utilize the present invention in various embodiments and with various modifications as are suited to the particular use contemplated. The features of the embodiments described herein may be combined in all possible combinations of methods, apparatus, modules, systems, and computer program products.

The above mentioned and described embodiments are only given as examples and should not be limiting to the present invention. Other solutions, uses, objectives, and functions within the scope of the invention as exemplary embodied in the above described claims should be apparent for the person skilled in the art.

1. A method in an arrangement for controlling a print output from a print device on an information carrier, the arrangement comprising a processing unit and a memory unit, the method comprising:
generating a print job data with respect to a type of print device, the information carrier and data in the memory unit,
analyzing the generated print job data for approval with respect to a number of predetermined parameters,
wherein the analyzing comprises simulating a printout in a printer by simulating the print job data and deciding the quality of the printout, and
wherein the method further comprises:
based on simulated printout results, varying the predetermined parameters to find out the most suitable parameters.

2. The method of claim 1, further comprising:
generating the print job with respect to one or more of information receiver type, print surface material, information receiver coating, colour, gloss, reflectance, bleeding, optical density, absorbance, photo aging, environment parameters, temperature, humidity, illumination, print surface speed, print objects distance, or print objects angle.

3. The method of claim 1, further comprising:
generating the print job with respect to one or more of dot frequency, coalescence of separately deposited drops, droplet deposition, jet staggering, jet speed, jet channel crosstalk, ink type, ink viscosity, ink drop shape, ink colour, laser type, laser wavelength, dwell time, pixel spacing, laser power, or optical characteristics being one or more of barrel distortion, vignetting, galvo inertia, mirror inertia, print head voltage, thermal hysteresis, thermal neighboring dot crosstalk, strobe time, strobe shape, ribbon type, ribbon density, ribbon colour, ribbon speed, resolution, dot size, or dot shape.

4. The method of claim 1, further comprising:
simulating and testing barcode quality, the simulating and testing comprising one or more of edge determination, minimum reflectance, symbol contrast, minimum edge contrast, modulation, defects, decode or decodability.

5. The method of claim 1, further comprising:
simulating and testing two dimensional matrix symbols comprising one or more of symbol contrast, modulation, decode, unused error correction, fixed (finder) pattern damage, grid non-uniformity or axial non-uniformity.

6. The method of claim 1, further comprising:
simulating and testing characters comprising one or more of global image analyses, grayscale image analyses, analyses of lines and line patterns, analyses of point patterns, and frequency domain analyses , contrast analyses, edge analyses, spatial analyses, density analyses, histogram analyses, pattern recognition, shape recognition, or optical character recognition.

7. The method of claim 1, further comprising:
providing a simulation result to a controller for generating print job data with respect to the simulation result.

8. The method of claim 1, further comprising:
simulating simultaneous simulation of several types of printers in a production line.

9. A print controlling arrangement comprising:
a processing unit;
a memory unit; and
a communication unit for analyzing and testing a print output,
wherein the processing unit is configured to obtain a print job data comprising at least one image, the print job data being generated with respect to a type of print device, an information carrier and data in the memory unit, and analyzing the generated print job data for approval with respect to a number of predetermined parameters,
wherein the analyzing comprises simulating a printout in a printer by simulating the print job data and deciding the quality of the printout, and
wherein the processing unit is further configured to:
based on simulated printout results, vary the predetermined parameters to find out the most suitable parameters.

10. The print controlling arrangement of claim 9, wherein the print job data is generated with respect to one or more of information receiver type, print surface material, information receiver coating, colour, gloss, reflectance, bleeding, optical density, absorbance, photo aging, environment parameters, temperature, humidity, illumination, print surface speed, print objects distance, or print objects angle.

11. The print controlling arrangement of claim 9, wherein the print job data is generated with respect to one or more of: dot frequency, coalescence of separately deposited drops, droplet deposition, jet staggering, jet speed, jet channel crosstalk, ink type, ink viscosity, ink drop shape, ink colour, laser type, laser wavelength, dwell time, pixel spacing, laser power, optical characteristics, barrel distortion, vignetting, galvo inertia, mirror inertia, print head voltage, thermal hysteresis, thermal neighboring dot crosstalk, strobe time, strobe shape, ribbon type, ribbon density, ribbon colour, ribbon speed, resolution, dot size, or dot shape.

12. The print controlling arrangement of claim 9, further configured to:
simulate and test barcode quality, the simulation and test comprising one or more of edge determination, minimum reflectance, symbol contrast, minimum edge contrast, modulation, defects, decode, or decodability.

13. The print controlling arrangement of claim 9, further configured to:
simulate and test two dimensional matrix symbols comprising one or more of symbol contrast, modulation, decode, unused error correction, fixed (finder) pattern damage, grid non-uniformity, or axial non-uniformity.

14. The print controlling arrangement of claim 9, further configured to:
simulate and test characters comprising one or more of global image analyses, grayscale image analyses, analyses of lines and line patterns, analyses of point patterns, and frequency domain analyses, contrast analyses, edge analyses, spatial analyses, density analyses, histogram analyses, pattern recognition, shape recognition, or optical character recognition.

15. The print controlling arrangement of claim 9, further configured to:
determine one or more printer types connected in a network.

16. The print controlling arrangement of claim 9, further comprising:
means for generating new parameters for new analyses.

17. A computer-readable medium comprising a plurality of computer-readable instructions for execution by a processor of a computer device, wherein execution of the instructions causes the processor to perform steps of:
generating a print job data with respect to a type of print device, an information carrier characteristics and data in from a memory unit,
analyzing the generated print job data for approval with respect to a number of predetermined parameters,
wherein the analyzing comprises simulating a printout in a printer by simulating the print job data and deciding the quality of the printout, and
wherein the execution of the instructions further causes the processor to perform steps of:
based on simulated printout results, varying the predetermined parameters to find out the most suitable parameters.
